(19) United States
(12) Patent Application Publication
(10) Pub. No.: US 2024/0256642 A1
(43) Pub. Date: Aug. 1, 2024

(54) DEVICE ACTIONS BASED ON AUTHENTICATED MULTI-TOUCH GESTURES

(71) Applicant: Motorola Mobility LLC, Chicago, IL (US)

(72) Inventors: Ranjeet Gupta, Naperville, IL (US); Thomas Yates Merrell, St Charles, IL (US); Rakshit Khosla, Hawthorn Woods, IL (US)

(73) Assignee: Motorola Mobility LLC, Chicago, IL (US)

(21) Appl. No.: 18/101,699

(22) Filed: Jan. 26, 2023

(51) Int. Cl. G06F 21/32; G06F 21/12; G06F 21/44; G06V 40/12

(52) U.S. Cl. CPC G06F 21/32; G06F 21/121; G06F 21/44; G06V 40/1365; G06F 2221/2137

(57) ABSTRACT

In aspects of device actions based on authenticated multi-touch gestures, a multi-touch gesture is received via a fingerprint sensor of a mobile device. The multi-touch gesture includes at least a first touch event and a second touch event. First authentication data is collected during the first touch event, and second authentication data is collected during the second touch event. Based on a successful authentication of at least one of the first authentication data or the second authentication data, a device action corresponding to the multi-touch gesture is initiated.

### BACKGROUND

As technology has advanced, electronic devices have become increasingly powerful and capable of performing a multitude of tasks. For instance, an electronic device typically includes user authentication capability to request authentication information before a user is granted access to functionality of the electronic device. Many modern devices include biometric sensors (e.g., fingerprint scanners, microphones for voice detection, a camera for iris detection and facial recognition, etc.) which collect biometric information for use in authenticating a user. Due to the speed and ease with which biometric information is provided along with the added security associated with biometric authentication, device functionalities can be readily protected by biometric authentication.

### BRIEF DESCRIPTION OF THE DRAWINGS

Aspects of device actions based on authenticated multi-touch gestures are described with reference to the following Figures. The same numbers may be used throughout to reference similar features and components that are shown in the Figures. Further, identical numbers followed by different letters reference different instances of features and components described herein:

FIG. 1 illustrates an example environment in which aspects of device actions based on authenticated multi-touch gestures can be implemented;

FIG. 2 depicts an example system in which aspects of device actions based on authenticated multi-touch gestures can be implemented to combine sequential touch events into a single multi-touch event:

FIG. 3 depicts an example system in which aspects of device actions based on authenticated multi-touch gestures can be implemented to initiate a device action based on an authentication result of a multi-touch gesture:

FIG. 4 depicts an example showing a device action initiated based on an authenticated multi-touch gesture received while a mobile device is locked:

FIG. 5a depicts an example showing a device action initiated based on an unauthenticated multi-touch gesture while a mobile device is unlocked:

FIG. 5b depicts an example showing a device action initiated based on an authenticated multi-touch gesture while a mobile device is unlocked:

FIG. 6a depicts an example showing a device action initiated based on an authenticated multi-touch gesture that includes a first combination of touch events.

FIG. 6b depicts an example showing a device action initiated based on an authenticated multi-touch gesture that includes a second combination of touch events.

FIG. 6c depicts an example showing a device action initiated based on an authenticated multi-touch gesture that includes the first combination of touch events performed by a different finger of a user.

FIG. 7 depicts an example procedure for device actions based on authenticated multi-touch gestures in accordance with one or more implementations.

FIG. 8 illustrates various components of an example device that can implement aspects of device actions based on authenticated multi-touch gestures.

### DETAILED DESCRIPTION

Techniques for device actions based on authenticated multi-touch gestures are described herein as implemented by a multi-touch authentication module of a mobile device. The mobile device includes a fingerprint sensor which, when touched by a user, collects fingerprint data describing unique characteristics of a fingerprint of the user that can be used to authenticate the user. In accordance with the described techniques, the multi-touch authentication module receives, via the fingerprint sensor, sequential touch events that include at least a first touch event and a second touch event. A touch event combination module is employed to combine the first and second touch events into a single multi-touch event if the first and second touch events are received within a timeout period. In one or more implementations, the timeout period is a duration of time during which consecutive individual touch events of the sequential touch events are to be received. By way of example, the touch event combination module generates a multi-touch event that includes the first touch event and the second touch event in response to determining that the second touch event is received within the duration of time defined by the timeout period of the first touch event being received.

First authentication data is collected by the fingerprint sensor during the first touch event, and second authentication data is collected by the fingerprint sensor during the second touch event. A fingerprint authentication module is employed to attempt to authenticate the first touch event using the first authentication data, and to attempt to authenticate the second touch event using the second authentication data. If at least one of the first touch event or the second touch event is successfully authenticated, then the fingerprint authentication module authenticates the entire multi-touch gesture as being received from an authorized user of the mobile device. In one or more implementations, the multi-touch authentication module imposes a lockout of the fingerprint sensor in response to a threshold number of unsuccessful authentication attempts. By combining the multiple individual touch events into a single authentication attempt, an unsuccessful authentication attempt of the multi-touch event counts as only one unsuccessful authentication attempt for a potential lockout of the fingerprint sensor. This is true despite multiple individual touch events of the multi-touch event each resulting in an authentication failure.

A memory of the mobile device maintains multiple multi-touch gestures, which are combinations of two or more gesture types (e.g., tap events, touch and hold events, touch and swipe events, touch and rotate events). Each of the multi-touch gestures correspond to one of multiple device actions, such that when a particular multi-touch gesture is performed, a corresponding device action is initiated. First touch data is collected during the first touch event, and second touch data is collected during the second touch event. The touch data indicates a manner in which a respective touch event is received, and can be used to identify gesture types associated with the individual touch events of the multi-touch gesture. For example, a gesture identification module is employed to identify a first gesture type associated with the first touch event, and a second gesture type associated with the second touch event. Further, the gesture identification module identifies a multi-touch gesture that corresponds to the first gesture type followed by the second gesture type, and a device action that corresponds to the identified multi-touch gesture. In one example, the first and second touch events are received as two consecutive tap events (e.g., a double tap gesture), and the gesture identification module identifies a device action corresponding to the double tap gesture as launching a messaging application of the mobile device.

Based on whether the multi-touch gesture is successfully authenticated, the multi-touch authentication module initiates the identified device action. Continuing with the previous example, if at least one of the individual touch events of the double tap gesture is successfully authenticated, then the multi-touch authentication module initiates launching the messaging application. If, however, none of the individual touch events of the double tap gesture are successfully authenticated, then the multi-touch authentication module does not initiate launching the application. Different combinations of individual touch events correspond to different device actions. For example, a double tap gesture corresponds to launching a messaging application, while a tap gesture followed by a swipe gesture corresponds to launching a camera application. Further, a same combination of individual touch events as performed by different fingers of a user initiate different device actions. In addition to authenticating a user, the fingerprint authentication module is able to identify a particular finger (e.g., right thumb, left thumb, right pointer finger, left pointer finger) with which the user provided the multi-touch gesture. In this way, a double tap gesture as performed by a right thumb of the user initiates a different device action then a double tap gesture as performed by a right pointer finger of the user, for example. Accordingly, by having different combinations of gesture types and different fingers correspond to different device actions, the described techniques increase a number of device actions that are initiable by authenticated multi-touch gestures.

By collecting, during a multi-touch event, touch data indicating a particular multi-touch gesture and a corresponding device action as well as authentication data which can be used to authenticate the user that performed the multi-touch gesture, the described techniques enable a variety of functionality that is not possible for conventional techniques that initiate actions based on unauthenticated gestures. Indeed, the described techniques can initiate an authentication action as well as a device application action in response to receiving a multi-touch gesture. In one example, if an authenticated multi-touch gesture is received while the mobile device is locked, the multi-touch authentication module can initiate a biometrically authenticated unlock of the mobile device as well as the device action of launching a particular device application. In another example, if an authenticated multi-touch gesture is received while the device is locked, the multi-touch authentication module can initiate launching a device application as well as a biometrically authenticated login to a user account associated with the device application.

Since conventional techniques do not authenticate gesture-initiated actions, a conventionally configured device that receives a gesture to launch an application while the device is locked would request a further user interaction to provide authentication information (e.g., a password, a pin, biometric information) to unlock the device before the application could be launched. Similarly, a conventionally configured device that receives a gesture to launch and login to a secure application while the device is unlocked would request a further user interaction to provide authentication information (e.g., a password, a pin, biometric information) to login to a user account associated with the secure application. Accordingly, the multi-touch authentication module improves user experience interacting with the mobile device since fewer interactions with the mobile device are utilized to initiate a desired action.

While features and concepts of the described techniques for device actions based on authenticated multi-touch gestures can be implemented in any number of different devices, systems, environments, and/or configurations, implementations of the techniques for device actions based on authenticated multi-touch gestures are described in the context of the following example devices, systems, and methods.

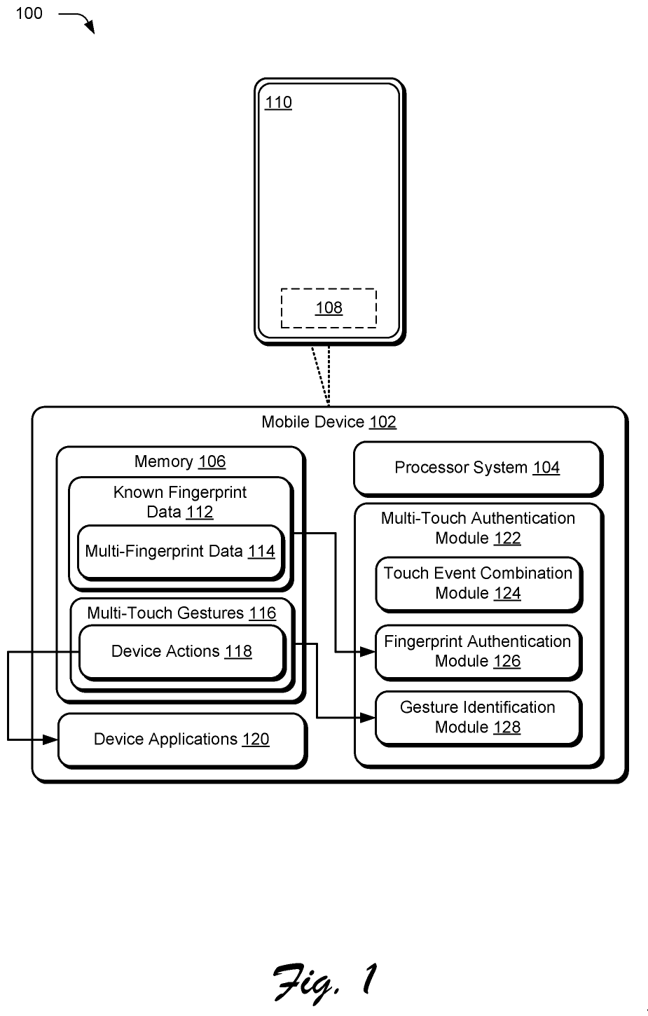

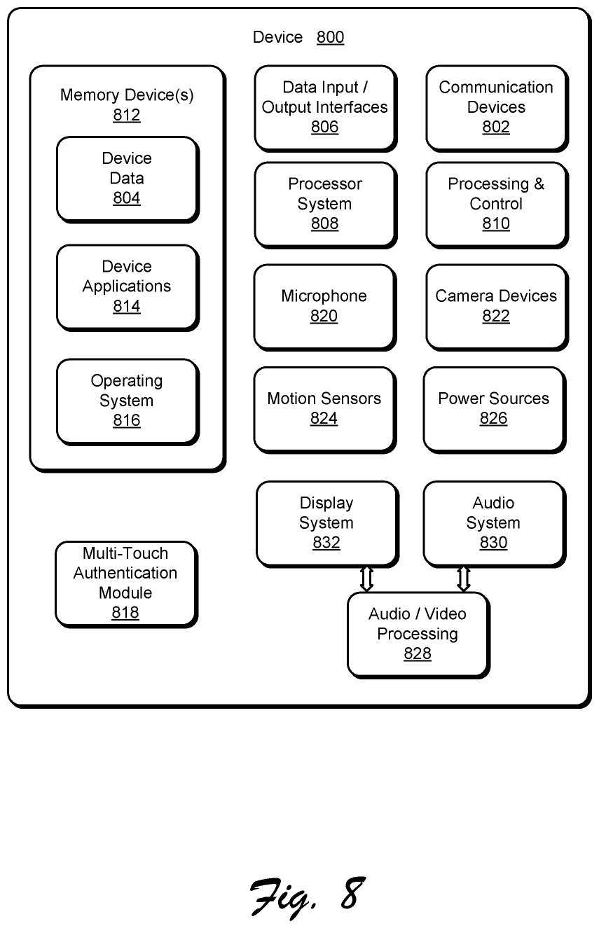

FIG. 1 illustrates an example environment 100 in which aspects of device actions based on authenticated multi-touch gestures can be implemented. The environment 100 includes a mobile device 102, which may be any type of a mobile phone, flip phone, computing device, tablet device, and/or any other type of mobile device. Generally, the mobile device 102 may be any type of an electronic, computing, and/or communication device implemented with various components, such as a processor system 104 and a memory 106, as well as any number and combination of different components as further described with reference to the example device shown in FIG. 8.

The mobile device 102 includes a fingerprint sensor 108, which when touched, collects data describing a fingerprint of a user that can be used to authenticate the user. In one or more implementations, the fingerprint sensor 108 is an under-display fingerprint sensor in which a display 110 is a topmost layer of the mobile device 102, and the fingerprint sensor 108 is located in between the display 110 and a back housing of the mobile device 102. As shown, the fingerprint sensor 108 is illustrated as a rectangular strip, however, it is to be appreciated that the size and shape of the fingerprint sensor 108 can vary. In additional or alternative implementations, the fingerprint sensor 108 is an integrated component of the display 110 rather than located underneath the display 110. Additionally or alternatively, the fingerprint sensor 108 is an integrated component of a front housing of the mobile device 102 proximate the display 110, and as such, is not a component of the display 110. It is to be appreciated that the fingerprint sensor 108 can be any type of fingerprint sensor, including but not limited to an optical fingerprint sensor, a capacitance fingerprint sensor, an ultrasonic fingerprint sensor, a thermal fingerprint sensor, etc. Further, the display 110 represents functionality (e.g., hardware and logic) for enabling visual output of content by the mobile device 102 (e.g., via a user interface), and in various implementations, the display 110 is a touch-sensitive display, enabling receipt of touch inputs via the display 110.

The memory 106 is illustrated as maintaining known fingerprint data 112, which is fingerprint data associated with a user that is authorized to access functionality and content of the mobile device 102. Broadly, when access to secure content and/or secure functionality of the mobile device 102 is requested (e.g., a user attempts to unlock the mobile device 102 or access a secure device application), fingerprint data is collected via the fingerprint sensor 108 and compared to the known fingerprint data 112. If the collected fingerprint authentication data matches the known fingerprint data 112, then access to the requested content and/or requested functionality is granted. The known fingerprint data 112 includes fingerprint data associated with any number of users authorized to access the functionality and content of the mobile device 102. Further, the known fingerprint data 112 includes, for each of the users that are authorized to access the functionality and content of the mobile device 102, multi-fingerprint data 114 associated with multiple fingers of each of the users. By way of example, the memory 106 includes known fingerprint data 112 associated with a right thumb, a left thumb, a right pointer finger, a left pointer finger, a right middle finger, a left middle finger, and so on, of a respective user of the mobile device 102.

The memory 106 is further illustrated as including multi-touch gestures 116, which are combinations of two or more gesture types. By way of example and not limitation, different gesture types include tap events, touch and hold events, touch and swipe events, touch and rotate events, and so on. In implementations, one or more of the multi-touch gestures 116 include multiple touch events that are of a same gesture type (e.g., a tap event followed by a tap event is a first multi-touch gesture 116 while a touch and swipe event followed by another touch and swipe event is a second multi-touch gesture 116). Furthermore, one or more of the multi-touch gestures 116 include multiple gestures where at least one of the multiple gestures is a different gesture type (e.g., a tap event followed by a touch and swipe event is a third multi-touch gesture 116, while a tap event followed by a touch and hold event is a fourth multi-touch gesture 116). Moreover, the multi-touch gestures 116 can include any number of touch events (e.g., three sequential tap events is a different multi-touch gesture 116 than two sequential tap events). Thus, the multi-touch gestures 116 can include any number and any combination of a variety of gesture types without departing from the spirit or scope of the described techniques.

Each of the multi-touch gestures 116 correspond to one of multiple device actions 118, such that when a particular multi-touch gesture 116 is performed, a corresponding device action 118 is initiated. As shown, the mobile device 102 includes device applications 120, and the device actions 118 invoke functionality of the device applications 120. In one or more implementations, different multi-touch gestures 116 invoke different device applications 120. By way of example, a first multi-touch gesture 116 corresponds to a first device action 118 which initiates launching a messaging application, while a second multi-touch gesture 116 corresponds to a second device action 118 which initiates launching a camera application. Additionally or alternatively, different multi-touch gestures 116 invoke different functionality of a same device application 120. By way of example, a third multi-touch gesture 116 corresponds to a third device action 118 which initiates a payment request via an online payment application, while a fourth multi-touch gesture 116 corresponds to a fourth device action 118 which initiates a transfer of funds via an online payment application. In one or more implementations, a same sequence of touch events (e.g., a tap event followed by a tap event) correspond to different device actions 118 as performed by different users and/or different fingers of a respective user.

In accordance with the described techniques, a multi-touch authentication module 122 receives multiple individual touch events of a multi-touch gesture 116, and initiate a corresponding device action 118 based on a successful authentication of at least one of the multiple touch events. To do so, the multi-touch authentication module 122 receives sequential touch events including at least a first touch event and a second touch event. The fingerprint sensor 108 collects first authentication data during the first touch event and second authentication data during the second touch event. Further, first touch data is collected during the first touch event and second touch data is collected during the second touch event (e.g., by the touch-sensitive display 110 and/or the fingerprint sensor 108). A touch event combination module 124 is employed to combine the individual touch events of the multiple touch events into a single multi-touch event. To do so, in one example, the touch event combination module 124 determines whether the first touch event and the second touch event are received within a timeout period (e.g., fifty milliseconds) of one another. If so, then the touch event combination module 124 generates a multi-touch event which includes the first touch event (including the first authentication data and the first touch data) and the second touch event (including the second authentication data and second touch data).

The multi-touch event including the multiple individual touch events is provided to the fingerprint authentication module 126, which attempts to authenticate the first authentication data and/or the second authentication data. To do so, the fingerprint authentication module 126 compares the first authentication data and the second authentication data to the known fingerprint data 112. If a match is found in the known fingerprint data 112 for at least one of the first authentication data or the second authentication data, then the fingerprint authentication module 126 outputs a successful authentication of the multi-touch event.

The multi-touch event including the multiple individual touch events is further provided to the gesture identification module 128, which identifies a multi-touch gesture 116 corresponding to the combination of the first touch event and the second touch event. For example, the gesture identification module 128 identifies a first gesture type based on the first touch data and a second gesture type based on the second touch data. Based on the first gesture type and the second gesture type, the gesture identification module 128 identifies a particular multi-touch gesture 116 and a corresponding device action 118. If the first and/or second authentication data was successfully authenticated by the fingerprint authentication module 126, then the multi-touch authentication module 122 causes the corresponding device action 118 to be initiated. If, however, neither the first nor the second authentication data was successfully authenticated by the fingerprint authentication module 126, then the multi-touch authentication module 122 does not cause the corresponding device action 118 to be initiated.

Conventional techniques for initiating actions based on gestures do so without authenticating the gestures. Indeed, a conventionally configured device may initiate an action based on a received touch gesture, but does not collect fingerprint data while the touch gesture is received to authenticate the gesture as received by an authorized user of the conventionally configured device. If authentication information is required to perform an action requested by a particular gesture, then the conventionally configured device would request an additional user interaction to provide authentication information in order to perform the requested action. In contrast, the described techniques collect touch data indicating a particular multi-touch gesture and a corresponding device action as well as authentication data which can be used to authenticate the user that performed the multi-touch gesture. By doing so, the described techniques enable a variety of functionality that is not possible for conventionally configured devices.

By way of example, input of a multi-touch gesture 116 performed in accordance with the described techniques can initiate an authentication action as well as a device application action (i.e., initiate the authentication action in combination with the device application action). As a specific example, if an authenticated multi-touch gesture is received while the mobile device 102 is locked, the authenticated multi-touch gesture can initiate a biometrically authenticated unlock of the mobile device 102 as well as the device action 118 of launching a particular device application 120. In contrast, a conventionally configured device that receives a gesture to launch an application while the device is locked would request a further user interaction to provide authentication information (e.g., a password, a pin, biometric information) to unlock the device before the application could be launched.

Having discussed an example environment in which the disclosed techniques can be performed, consider now some example scenarios and implementation details for implementing the disclosed techniques.

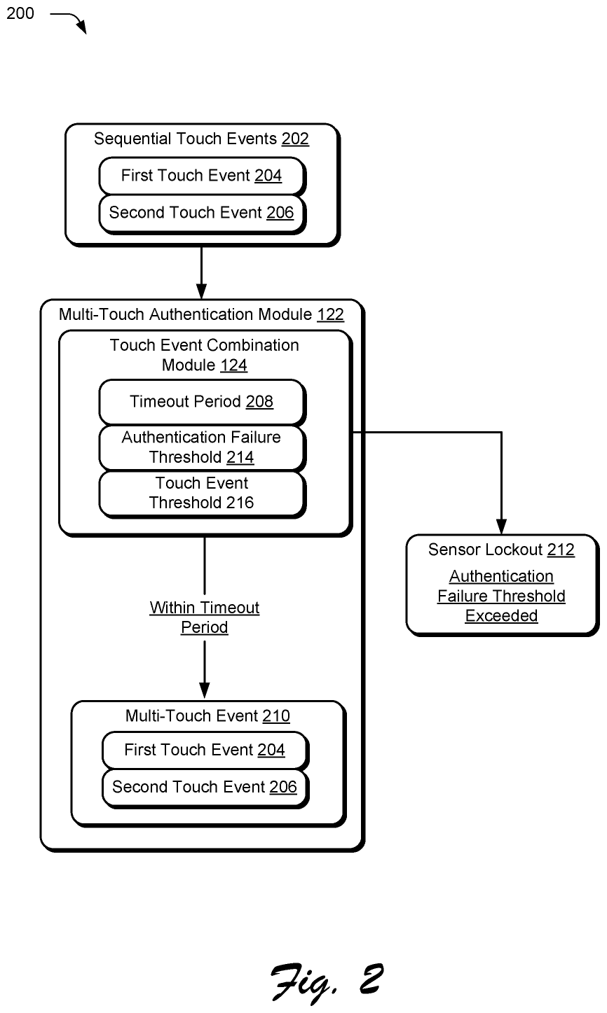

FIG. 2 depicts an example system 200 in which aspects of device actions based on authenticated multi-touch gestures can be implemented to combine sequential touch events into a single multi-touch event. By way of example, the multi-touch authentication module 122 receives sequential touch events 202 including at least a first touch event 204 and a second touch event 206. Although illustrated as including only two touch events, it is to be appreciated that the sequential touch events 202 can include more than two touch events without departing from the spirit or scope of the described techniques.

The sequential touch events 202 are provided to the touch event combination module 124, which determines whether the sequential touch events 202 are received within a timeout period 208. In one example, the timeout period 208 is a duration of time during which an entire multi-touch gesture is to be completed. For instance, the timeout period 208 is three-hundred milliseconds, and any touch events received within three-hundred milliseconds of the first touch event 204 of the sequential touch events 202 are received within the timeout period 208. In another example, the timeout period 208 is a duration of time during which consecutive individual touch events of the sequential touch events are to be received. For instance, the timeout period 208 is fifty milliseconds, and any touch event received within fifty milliseconds of a previous touch event of the sequential touch events 202 is received within the timeout period 208. If the first touch event 204 and the second touch event 206 are received within the timeout period, then the touch event combination module 124 generates a multi-touch event 210 that includes the first touch event 204 and the second touch event 206. In this way, an authentication attempt of the multi-touch event 210 corresponds to only one authentication attempt, despite the fingerprint authentication module 126 attempting to authenticate the first touch event 204 and the second touch event 206.

In one or more implementations, the multi-touch authentication module 122 imposes a sensor lockout 212 of the fingerprint sensor 108 in response to an authentication failure threshold 214 being exceeded Consider an example in which a user is attempting to unlock the mobile device 102 using fingerprint authentication data. After fingerprint authentication data has been provided and unsuccessfully authenticated a threshold number of times (e.g., five times), the multi-touch authentication module 122 imposes the sensor lockout 212 of the fingerprint sensor 108. In other words, the multi-touch authentication module 122 prevents the use of fingerprint data to unlock the mobile device 102, and instead, requests a different form of authentication data (e.g., a password or a pin). Thus, by combining the sequential touch events 202 into a single multi-touch event 210, an unsuccessful authentication attempt of the multi-touch event 210 is considered only one unsuccessful authentication attempt for a potential lockout of the fingerprint sensor 108. This is true despite the fingerprint authentication module 126 unsuccessfully authenticating each individual touch event included in the multi-touch event 210.

Consider an example in which a multi-touch gesture 116 includes three touch events and the fingerprint sensor 108 is locked out in response to five unsuccessful authentication attempts. If each individual touch event counted as an unsuccessful authentication attempt, such as with a conventional device configuration, a lockout would be imposed on the fingerprint sensor 108 in response to only one complete attempt of the multi-touch gesture 116, in this example. For instance, if each individual touch event is unsuccessfully authenticated, the fingerprint sensor 108 is locked based on a first complete attempt of the multi-touch gesture 116 (e.g., including three individual touch events) and a second incomplete attempt of the multi-touch gesture 116 (e.g., including only two individual touch events). Therefore, by combining the multiple touch events into a single multi-touch event 210, the touch event combination module 124 improves user experience interacting with the mobile device 102 by enabling more attempts to input the multi-touch gesture 116.

Notably, an unauthorized user having an unlimited number of touch events within the timeout period 208, may be able to provide a single touch event that leads to a successful authentication. Thus, to prevent an unauthorized user from “hacking” the mobile device 102, the touch event combination module 124 imposes a touch event threshold 216. The touch event threshold 216 is a limit to the number of individual touch events that can be considered as part of the multi-touch event 210. By way of example, the touch event threshold 216 is five touch events. In this example, although six touch events are received within the timeout period 208, the sixth touch event is not considered part of the multi-touch event 210.

If the first touch event 204 and the second touch event 206 are not received within the timeout period 208, then the touch event combination module 124 does not combine the touch events 204, 206 into a multi-touch event 210. Instead, the first touch event 204 and the second touch event 206 are provided to an operating system executing on the mobile device 102, which treats the first touch event 204 and second touch event 206 as single touch interactions. By way of example, the first touch event 204 is received via the fingerprint sensor 108 and on an application icon of a user interface displayed on the display 110. Since the first touch event 204 is not part of a multi-touch event, the first touch event 204 initiates launching of the selected application, rather than a device action 118 corresponding to a multi-touch gesture 116.

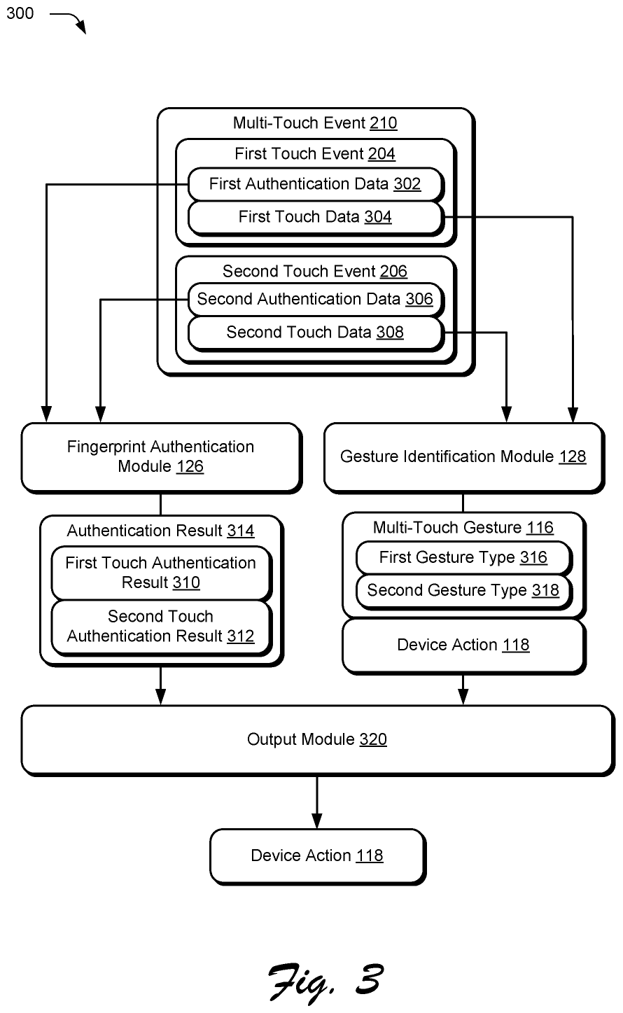

FIG. 3 depicts an example system 300 in which aspects of device actions based on authenticated multi-touch gestures can be implemented to initiate a device action based on an authentication result of a multi-touch gesture. As shown, the multi-touch event 210 generated by the touch event combination module 124 includes first authentication data 302 and first touch data 304 collected during the first touch event 204. Further, the multi-touch event 210 includes second authentication data 306 and second touch data 308 collected during the second touch event 206. The first and second authentication data 302, 306 are collected by the fingerprint sensor 108. Further, the first and second touch data 304, 308 can be collected by the fingerprint sensor 108 and/or the touch-sensitive display 110. In one or more implementations, the mobile device 102 includes multiple fingerprint sensors 108 located on different sides of the mobile device 102. In accordance with these implementations, the first authentication data 302 and the first touch data 304 can be collected by a first fingerprint sensor 108 (e.g., located on a front side of the mobile device 102). Further, the second authentication data 306 and the second touch data 308 can be collected by a second fingerprint sensor 108 (e.g., located on a back side of the mobile device 102).

The first authentication data 302 and the second authentication data 306 include fingerprint data describing unique characteristics of a fingerprint of a user that provided input of the multi-touch event 210. The fingerprint authentication module 126 receives the first and second authentication data 302, 306 and attempts to authenticate the first touch event 204 and the second touch event 206 using the first and second authentication data 302, 306. To attempt to authenticate the first touch event 204, for instance, the fingerprint authentication module 126 compares the first authentication data 302 to the known fingerprint data 112 to generate a first touch authentication result 310. The first touch authentication result 310 is a success if the first authentication data 302 matches the known fingerprint data 112, or the first touch authentication result 310 is a failure if the first authentication data 302 does not match the known fingerprint data 112. To attempt to authenticate the second touch event 206, for instance, the fingerprint authentication module 126 compares the second authentication data 306 to the known fingerprint data 112 to generate a second touch authentication result 312. The second touch authentication result 312 is a success if the second authentication data 306 matches the known fingerprint data 112, or the second touch authentication result 312 is a failure if the second authentication data 306 does not match the known fingerprint data 112.

Based on the first touch authentication result 310 and the second touch authentication result 312, the fingerprint authentication module 126 generates an authentication result 314 of the entire multi-touch event 210. In one or more implementations, the authentication result 314 of the multi-touch event 210 is a success if at least one individual touch event of the multi-touch event 210 results in a successful authentication. Given this, if each individual touch event of the multi-touch event 210 results in a failed authentication, then the authentication result 314 of the multi-touch event is a failure. Additionally or alternatively, the authentication result 314 of the multi-touch event 210 is a success if each individual touch event of the multi-touch event 210 results in a successful authentication (e.g., if both individual touch events are authenticated). Given this, if at least one individual touch event of the multi-touch event results in a failed authentication, then the authentication result 314 of the multi-touch event is a failure.

In one or more implementations, the fingerprint authentication module 126 identifies a particular user who input the multi-touch event 210 from multiple users that are authorized to access the mobile device 102. For example, the known fingerprint data 112 includes fingerprint data associated with the multiple users. Thus, when an individual touch event is successfully authenticated, the fingerprint authentication module 126 identifies the particular user associated with the known fingerprint data 112 that matches the collected authentication data 302, 306.

In accordance with the described techniques, the fingerprint authentication module 126 identifies a particular finger with which the multi-touch event 210 was provided. By way of example, the known fingerprint data 112 includes multi-fingerprint data 114 associated with multiple fingers of the user who input the multi-touch event 210. Thus, when an individual touch event is successfully authenticated, the fingerprint authentication module 126 identifies the particular finger associated with the known fingerprint data 112 that matches the collected authentication data 302, 306.

The first touch data 304 and the second touch data 308 are provided to the gesture identification module 128. The touch data 304, 308 indicates a manner in which the touch events 204, 206 are received. By way of example, the touch data 304, 308 indicates a time duration of the touch events 204, 206, a direction in which the touch events 204, 206 move across the touch-sensitive display 110, a degree of rotation in which the touch events 204, 206 move with respect to the touch-sensitive display 110, etc. Thus, based on the first touch data 304, the gesture identification module 128 identifies a first gesture type 316 (e.g., a tap event, a touch and hold event, a touch and swipe event, a touch and rotate event, or any other type of touch gesture). Further, based on the second touch data 308, the gesture identification module 128 identifies a second gesture type 318 (e.g., a tap event, a touch and hold event, a touch and swipe event, a touch and rotate event, or any other type of touch gesture). The gesture identification module 128 further identifies a particular multi-touch gesture 116 corresponding to the first gesture type 316 followed by the second gesture type 318. As previously noted, each of the multi-touch gestures 116 correspond to a device action 118, and as such, the gesture identification module 128 further identifies a device action 118 corresponding to the multi-touch gesture 116.

The multi-touch gesture 116 and the corresponding device action 118 are provided to an output module 320 along with the authentication result 314. In one or more implementations, the output module 320 initiates the device action 118 if the authentication result 314 of the multi-touch gesture 116 is a success. Consider an example in which the device action 118 corresponding to the multi-touch gesture 116 is to launch an online banking application. If the authentication result 314 of the multi-touch gesture 116 is a success, then the output module 320 causes the mobile device 102 to launch the online banking application. However, if the authentication result 314 of the multi-touch gesture 116 is a failure, the output module 320 does not launch the online banking application. In one or more implementations, a device action 118 is not initiated if the multi-touch gesture 116 is not authenticated. Additionally or alternatively, a different device action is initiated if the multi-touch gesture 116 is not authenticated, as further discussed below.

In one or more implementations, the multi-touch gesture 116 corresponds to a different device action 118 as performed by different authorized users of the mobile device 102. Consider an example in which the multi-touch gesture 116 is a tap event followed by another tap event (e.g., a double tap gesture). In this example, a double tap gesture performed by a first user corresponds to a device action 118 to launch a messaging application, while a double tap gesture performed by a second user corresponds to a different device action 118 to launch a camera application. Given this, the fingerprint authentication module 126 provides, to the gesture identification module 128, an indication of the particular user that input the multi-touch event 210. Further, the gesture identification module 128 identifies the device action 118 corresponding to the multi-touch gesture 116 and the user that provided the multi-touch gesture 116. In this way, when an authenticated double tap gesture is received as input by the first user, the output module 320 initiates launching of the messaging application. Further, when an authenticated double tap gesture is received as input by the second user, the output module 320 initiates launching the camera application.

In one or more implementations, the multi-touch gesture 116 corresponds to a different device action 118 as performed while accessing the functionality and content of the mobile device 102 via different user profiles of an authorized user of the mobile device 102. Consider an example in which an authorized user of the mobile device 102 maintains two user profiles (e.g., a personal profile, and a work profile) on the mobile device 102. In these implementations, the user may wish to have a particular multi-touch gesture 116 correspond to different device actions 118 depending on whether the user is accessing the content of the mobile device 102 via the personal profile or the work profile. By way of example, an authenticated double tap gesture as performed by a particular user corresponds to a device action 118 to launch a content streaming application while the particular user is logged in to the personal profile. Further, an authenticated double tap gesture as performed by the particular user corresponds to a different device action 118 to launch an email application while the particular user is logged in to the work profile.

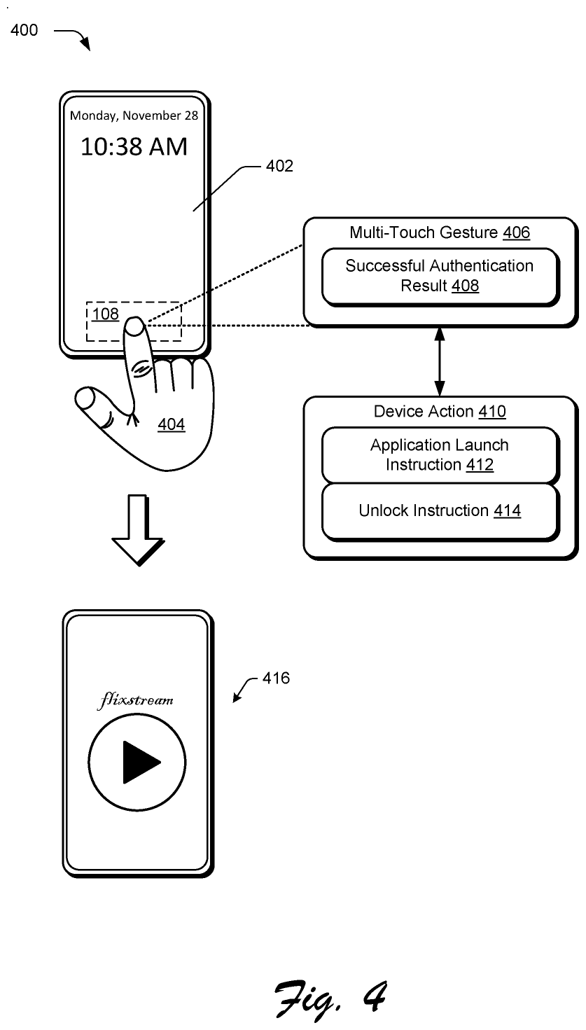

FIG. 4 depicts an example 400 showing a device action initiated based on an authenticated multi-touch gesture received while a mobile device is locked. In one or more implementations, an authenticated multi-touch gesture 116 is received while the mobile device 102 is locked, and the authenticated multi-touch gesture 116 initiates a biometrically authenticated unlock of the mobile device 102 and an action associated with a device application 120. As shown in the example 400, the mobile device 102 is displaying a lock screen 402 via the display 110. While the lock screen 402 is displayed, a user 404 inputs a particular multi-touch gesture 406 via the fingerprint sensor 108. In the example 400, at least one of the individual touch events of the multi-touch gesture 406 is authenticated by the fingerprint authentication module 126. Therefore, the multi-touch gesture 406 is associated with a successful authentication result 408. Further, the device action 410 that corresponds to the authenticated multi-touch gesture 406 includes an application launch instruction 412 to launch a content streaming application.

Since the mobile device 102 is locked at the time the multi-touch gesture 406 is received, the device action 410 also includes an unlock instruction 414 to unlock the mobile device 102. For example, the multi-touch authentication module 122 initiates a biometrically authenticated unlock of the mobile device 102 based on the successful authentication result 408 of the multi-touch gesture 406. Thus, in response to receiving the authenticated multi-touch gesture 406, the multi-touch authentication module 122 unlocks the mobile device 102 and launches the content streaming application, as shown at 416.

This functionality is not possible for conventionally configured devices that initiate actions based on gestures that are not authenticated. For example, if a conventionally configured device receives a gesture to initiate an action while the device is locked, an additional user interaction to provide authentication information (e.g., biometric information, a pin, a password, etc.) would be required of the user before any requested action can be initiated. In contrast, the multi-touch authentication module 122 initiates unlocking of the mobile device 102 and an action associated with a device application 120 (e.g., launching the device application 120) based on the multi-touch gesture 406. By doing so, the multi-touch authentication module 122 improves user experience interacting with the mobile device 102 since fewer interactions with the mobile device 102 are utilized to initiate a desired action.

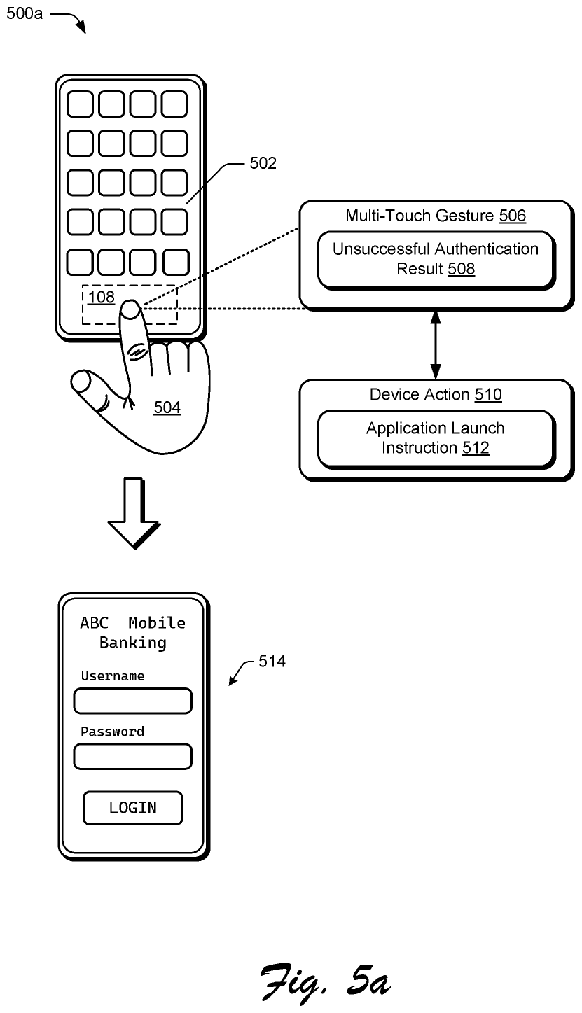

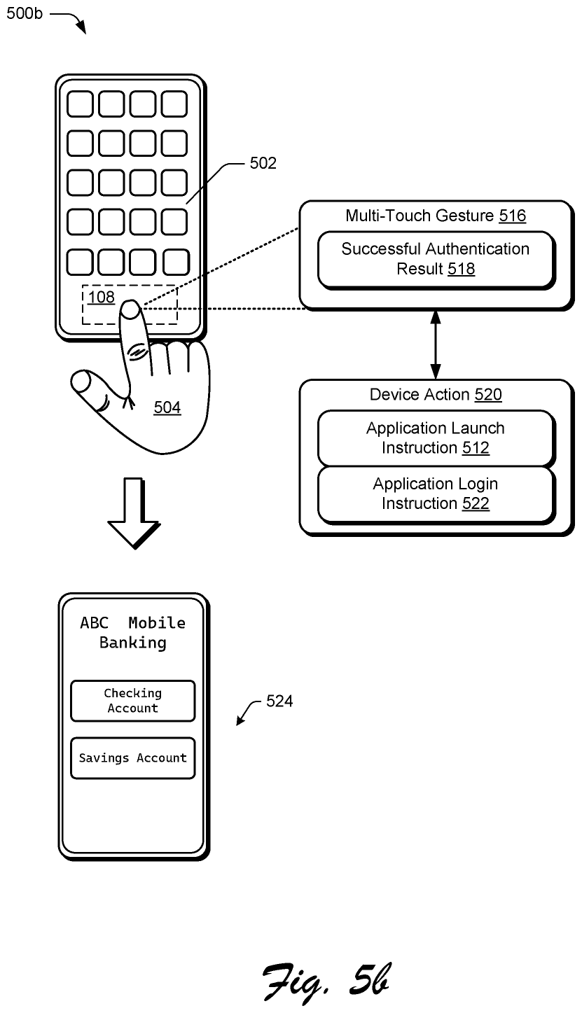

FIG. 5a depicts an example 500a showing a device action initiated based on an unauthenticated multi-touch gesture while a mobile device is unlocked. In one or more implementations, different device actions are initiated based on whether a particular multi-touch gesture 116 is successfully authenticated or unsuccessfully authenticated. As shown in the example 500a, the mobile device 102 is displaying a home screen 502 via the display 110 (e.g., the mobile device 102 is unlocked). While the home screen 502 is displayed, a user 504 inputs a particular multi-touch gesture 506 via the fingerprint sensor 108. In the example 500a, none of the individual touch events of the multi-touch gesture 506 are successfully authenticated by the fingerprint authentication module 126. Therefore, the multi-touch gesture 506 is associated with an unsuccessful authentication result 508. Further, the gesture identification module 128 identifies a device action 510 associated with the multi-touch gesture 506 and the unsuccessful authentication result 508. In the example 500a, for instance, the device action 510 includes an application launch instruction 512 to launch a mobile banking application, as shown at 514.

FIG. 5b depicts an example 500b showing a device action initiated based on an authenticated multi-touch gesture while a mobile device is unlocked. While the home screen 502 is displayed, the user 504 inputs a particular multi-touch gesture 516 via the fingerprint sensor 108. Notably, the multi-touch gesture 516 of example 500b includes the same combination of gesture types as the multi-touch gesture 506 of example 500a. In both examples 500a and 500b, for instance, the multi-touch authentication module 122 receives a multi-touch gesture as a tap event followed by another tap event (e.g., a double-tap gesture). However, in example 500b, at least one individual touch event of the multi-touch gesture 516 is successfully authenticated by the fingerprint authentication module 126. Therefore, the multi-touch gesture 516 in example 500b is associated with a successful authentication result 518. Further, the gesture identification module 128 identifies a device action 520 associated with the multi-touch gesture 516 and the successful authentication result 518. In the example 500b, for instance, the device action 520 includes the application launch instruction 512 to launch the mobile banking application and an application login instruction 522 to initiate a biometrically authenticated login to a user account of the mobile banking application, as shown at 524.

This functionality is not possible for conventionally configured devices, which initiate actions based on gestures that are not authenticated. For example, if a conventionally configured device receives a gesture to access content of a secure application (e.g., an application that requires a login to access the content), an additional user interaction to provide authentication information (e.g., biometric information, a pin, a password, etc.) would be required of the user before the content of the secure application can be accessed. In contrast, the multi-touch authentication module 122 initiates launching a secure application and a biometrically authenticated login to the secure application based on the multi-touch gesture 506. By doing so, the multi-touch authentication module 122 improves user experience interacting with the mobile device 102 since fewer interactions with the mobile device 102 are utilized to initiate a desired action.

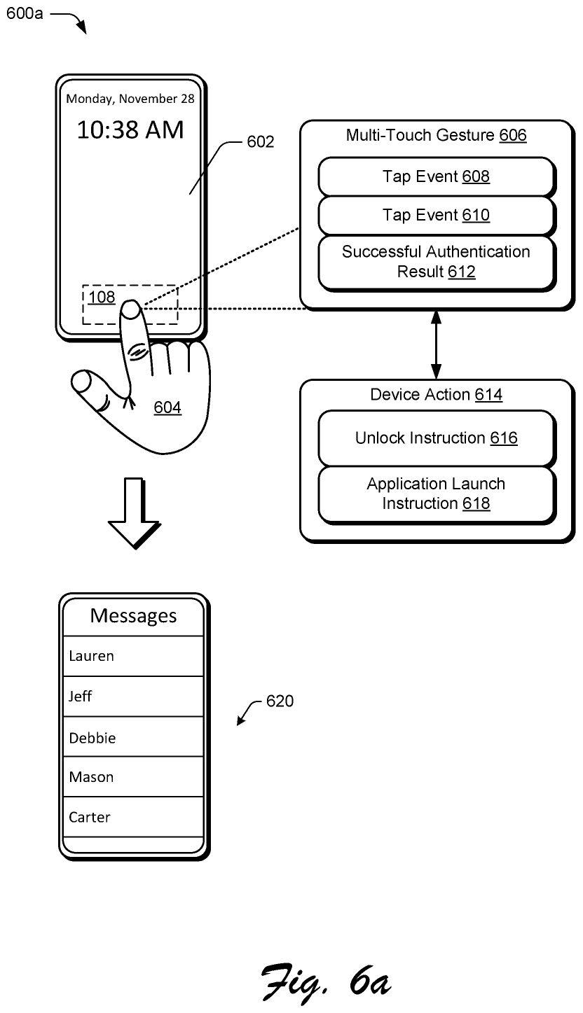

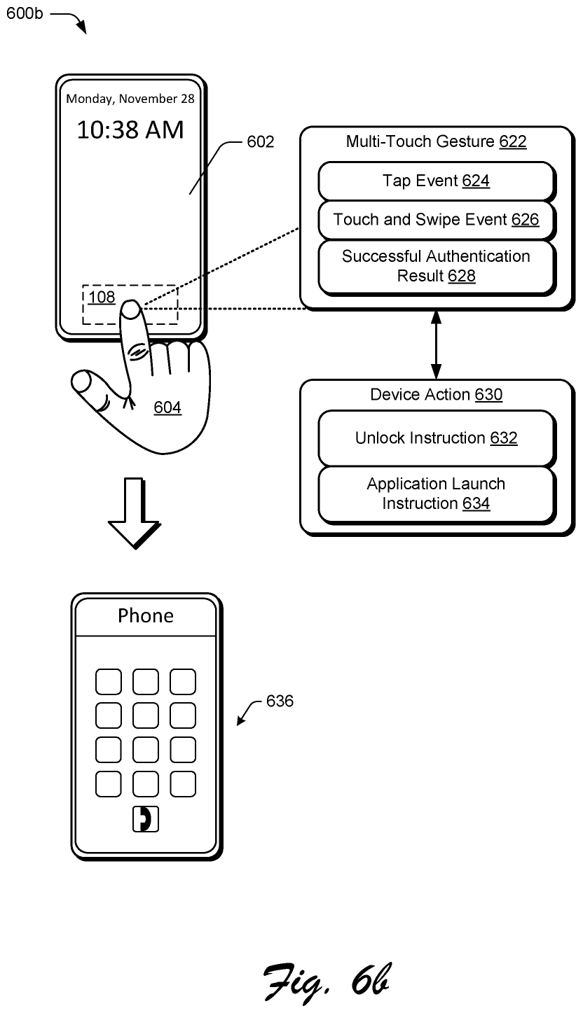

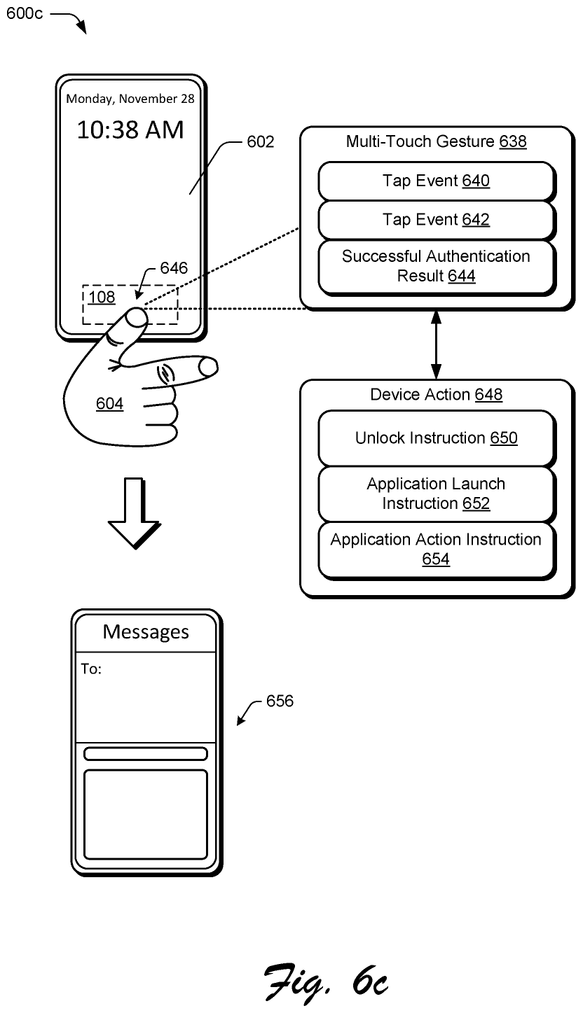

FIG. 6a depicts an example 600a showing a device action initiated based on an authenticated multi-touch gesture that includes a first combination of touch events. In one or more implementations, different multi-touch gestures 116 including different combinations of gesture types initiate different device actions 118. As shown in example 600a, the mobile device 102 is displaying a lock screen 602 via the display 110. While the lock screen 602 is displayed, a user 604 inputs a multi-touch gesture 606 via the fingerprint sensor 108 that includes a tap event 608 followed by another tap event 610 (e.g., a double tap gesture). In the example 600a, at least one of the tap events 608, 610 is successfully authenticated by the fingerprint authentication module 126. Therefore, the multi-touch gesture 606 is associated with a successful authentication result 612. Further, the gesture identification module 128 identifies a device action 614 associated with a tap event 608 followed by another tap event 610 and a successful authentication result 612. In the example 600a, for instance, the device action 614 includes an unlock instruction 616 to unlock the mobile device 102 and an application launch instruction 618 to launch a messaging application, as shown at 620.

FIG. 6b depicts an example 600b showing a device action initiated based on an authenticated multi-touch gesture that includes a second combination of touch events. While the lock screen 602 is displayed, the user 604 inputs a multi-touch gesture 622 via the fingerprint sensor 108 that includes a tap event 624 and a touch and swipe event 626. In the example 600b, at least one of the tap event 624 or the touch and swipe event 626 is successfully authenticated by the fingerprint authentication module 126. Therefore, the multi-touch gesture is associated with a successful authentication result 628. Further, the gesture identification module 128 identifies a device action 630 associated with a tap event 624 followed by a touch and swipe event 626 and a successful authentication result 628. In the example 600b, the device action 630 includes an unlock instruction 632 to unlock the mobile device 102 and an application launch instruction 634 to launch a phone application, as shown at 636. Although only two different combinations of gesture types are depicted and described with reference to examples 600a, 600b, it is to be appreciated that the multi-touch gestures 116 include any number of individual touch events having different combinations of gesture types. Further, different device actions 118 correspond to the different multi-touch gestures 116.

FIG. 6c depicts an example 600c showing a device action initiated based on an authenticated multi-touch gesture that includes the first combination of touch events performed by a different finger of a user. In one or more implementations, a same combination of gesture types as performed by different fingers of a user correspond to different device actions. While the lock screen 602 is displayed in this example 600c, the user 604 inputs a multi-touch gesture 638 that includes a tap event 640 followed by another tap event 642 (e.g., a double tap gesture). In the example 600c, at least one of the tap events 640, 642 is authenticated by the fingerprint authentication module 126. Therefore, the multi-touch gesture 638 is associated with a successful authentication 644. Given this, both the multi-touch gesture 606 of example 600a and the multi-touch gesture 638 of example 600c correspond to authenticated double-tap gestures. However, as shown at 646, the multi-touch gesture 638 of example 600c is performed by a thumb of the user 604, whereas the multi-touch gesture 606 of example 600a is performed by a pointer finger of the user 604.

In the example 600c, the gesture identification module 128 identifies a device action 648 associated with a successfully authenticated double tap gesture as performed by a thumb of the user 604. The device action 648 includes an unlock instruction 650 to unlock the mobile device 102, an application launch instruction 652 to launch the messaging application, and an application action instruction 654 to initiate a new message via the messaging application, as shown at 656. Thus, the device action 648 of example 600c corresponding to a successfully authenticated double tap gesture performed by a thumb of the user 604 is different than the device action 614 of example 600a corresponding to a successfully authenticated double tap gesture performed by a pointer finger of the user 604. In one or more implementations, different combinations of fingers can be used in a single multi-touch gesture 116 to initiate additional device actions. For example, an authenticated double-tap gesture including a first tap event performed by a pointer finger of the user 604 and a second tap event performed by a thumb of the user 604 corresponds to a further device action 118 that is different than both the device action 614 and the device action 648.

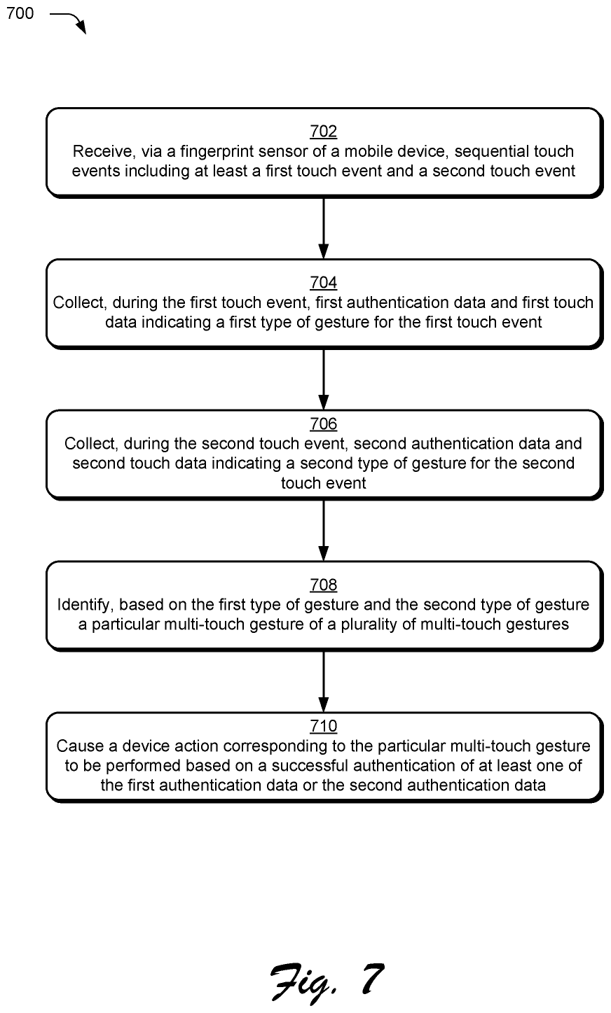

FIG. 7 depicts an example procedure 700 for device actions based on authenticated multi-touch gestures in accordance with one or more implementations. At 702, sequential touch events including at least a first touch event and a second touch event are received via a fingerprint sensor. By way of example, the fingerprint sensor 108 receives the sequential touch events 202 including the first touch event 204 and the second touch event 206.

At 704, first authentication data and first touch data are collected during the first touch event, the first touch data indicating a first type of gesture for the first touch event. By way of example, the multi-touch authentication module 122 collects first authentication data 302 using the fingerprint sensor 108 during the first touch event 204. The first authentication data 302, for instance, is fingerprint data describing the unique characteristics of a fingerprint of a user that provided the input of the first touch event 204, which can be used by the fingerprint authentication module 126 to authenticate the user. The multi-touch authentication module 122 additionally collects first touch data 304 using the fingerprint sensor 108 and/or the touch-sensitive display 110 during the first touch event 204. The first touch data 304, for instance, indicates a manner in which the first touch event 204 was provided, and is utilized by the gesture identification module 128 to identify a first gesture type 316 associated with the first touch event 204 (e.g., a tap event, a touch and hold event, a touch and swipe event, a touch and rotate event).

At 706, second authentication data and second touch data are collected during the second touch event, the second touch data indicating a second type of gesture for the second touch event. By way of example, the multi-touch authentication module 122 collects second authentication data 306 using the fingerprint sensor 108 during the second touch event 206. The second authentication data 306, for instance, is fingerprint data describing unique characteristics of a fingerprint of a user that provided the input of the second touch event 206, which can be used by the fingerprint authentication module 126 to authenticate the user. The multi-touch authentication module 122 additionally collects second touch data 308 using the fingerprint sensor 108 and/or the touch-sensitive display 110 during the second touch event 206. The second touch data 308, for instance, indicates a manner in which the second touch event 206 was provided, and is utilized by the gesture identification module 128 to identify a second gesture type 318 associated with the second touch event 206 (e.g., a tap event, a touch and hold event, a touch and swipe event, a touch and rotate event).

At 708, a particular multi-touch gesture of a plurality of multi-touch gestures is identified based on the first type of gesture and the second type of gesture. For example, the mobile device 102 maintains multiple multi-touch gestures 116 in the memory 106. Each of the multi-touch gestures 116 are associated with a particular combination of gesture types, a particular user of multiple users that are authorized to access content and functionality of the mobile device 102, and a particular finger of the particular user. The gesture identification module 128 receives from the fingerprint authentication module 126, a particular user that performed the first and second touch events 204, 206, and a particular finger of the particular user with which the first and second touch events 204, 206 were performed. Further, the gesture identification module 128 identifies from the collection of multi-touch gestures 116, a particular multi-touch gesture 116 corresponding to the particular user, the particular finger, and the particular combination of gesture types including the first gesture type 316 followed by the second gesture type 318. Each of the multi-touch gestures 116 correspond to a particular device action 118, such as launching a device application 120 (e.g., a messaging application) of the mobile device 102, or invoking some functionality of the device application 120 (e.g., initiating a new message via the messaging application). The gesture identification module 128 further identifies a particular device action 118 corresponding to the particular multi-touch gesture 116

At 710, a device action corresponding to the particular multi-touch gesture is caused to be performed based on a successful authentication of at least one of the first authentication data or the second authentication data. By way of example, the fingerprint authentication module 126 attempts to authenticate the first touch event 204 by comparing the first authentication data 302 to known fingerprint data 112 maintained in the memory 106. Further, the fingerprint authentication module 126 attempts to authenticate the second touch event 206 by comparing the second authentication data 306 to the known fingerprint data 112 maintained in the memory 106. Based on at least one of the first authentication data 302 or the second authentication data 306 being successfully authenticated, the particular multi-touch gesture 116 identified by the gesture identification module 128 is authenticated. Based on the particular multi-touch gesture 116 being authenticated, the multi-touch authentication module 122 initiates the particular device action 118 corresponding to the particular multi-touch gesture 116. In one or more implementations, the multi-touch authentication module 122 does not initiate a device action 118 if the particular multi-touch gesture 116 is not authenticated. Additionally or alternatively, the multi-touch authentication module 122 initiates a different device action 118 if the particular multi-touch gesture 116 is not authenticated.

FIG. 8 illustrates various components of an example device 800, which can implement aspects of the techniques and features for device actions based on authenticated multi-touch gestures, as described herein. The example device 800 can be implemented as any of the devices described with reference to the previous FIGS. 1-7, such as any type of a wireless device, mobile device, mobile phone, flip phone, client device, companion device, paired device, display device, tablet, computing, communication, entertainment, gaming, media playback, and/or any other type of computing and/or electronic device. For example, the mobile device 102 described with reference to FIGS. 1-7 may be implemented as the example device 800.

The example device 800 can include various, different communication devices 802 that enable wired and/or wireless communication of device data 804 with other devices. The device data 804 can include any of the various devices' data and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers for cellular phone communication and/or for any type of network data communication.

The example device 800 can also include various, different types of data input/output (I/O) interfaces 806, such as data network interfaces that provide connection and/or communication links between the devices, data networks, and other devices. The I/O interfaces 806 can be used to couple the device to any type of components, peripherals, and/or accessory devices, such as a computer input device that may be integrated with the example device 800. The I/O interfaces 806 may also include data input ports via which any type of data, information, media content, communications, messages, and/or inputs can be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a system-on-chip (SoC) that processes computer-executable instructions. The processor system 808 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 812 include volatile memory and non-volatile memory, fixed and removable media devices, and any suitable memory device or electronic data storage that maintains data for computing device access. The memory devices 812 can include various implementations of random-access memory (RAM), read-only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 can be maintained as software instructions with a memory device 812 and executed by the processor system 808 as a software application. The device applications 814 may also include a device manager, such as any form of a control application, software application, signal-processing and control module, code that is specific to a particular device, a hardware abstraction layer for a particular device, and so on.

In this example, the device 800 includes a multi-touch authentication module 818 that implements various aspects of the described features and techniques for device actions based on authenticated multi-touch gestures. The multi-touch authentication module can be implemented with hardware components and/or in software as one of the device applications 814, such as when the example device 800 is implemented as the mobile device 102 as described with reference to FIGS. 1-7. An example of the multi-touch authentication module 818 includes the multi-touch authentication module 122 that is implemented by the mobile device 102, such as a software application and/or as hardware components in the mobile device 102. In implementations, the multi-touch authentication module may include independent processing, memory, and logic components as a computing and/or electronic device integrated with the example device 800.

The example device 800 can also include a microphone 820 and/or camera devices 822, as well as motion sensors 824, such as may be implemented as components of an inertial measurement unit (IMU). The motion sensors 824 can be implemented with various sensors, such as a gyroscope, an accelerometer, and/or other types of motion sensors to sense motion of the device 800. The motion sensors 824 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources 826, such as when the device is implemented as a wireless device and/or mobile device. The power sources may include a charging and/or power system, and can be implemented as a flexible strip battery, a rechargeable battery, a charged super-capacitor, and/or any other type of active or passive power source.

The example device 800 can also include an audio and/or video processing system 828 that generates audio data for an audio system 830 and/or generates display data for a display system 832. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 800. Alternatively, the audio system and/or the display system are external, peripheral components to the example device.

As used herein, including in the claims, “or” as used in a list of items (e.g., a list of items prefaced by a phrase such as “at least one of” or “one or more of” or “based at least in part on”) indicates an inclusive list such that, a list of at least one of A, B, or C means A or B or C or AB or AC or BC or ABC (i.e., A and B and C). Further, as used herein, the phrase “based on” shall not be construed as a reference to a closed set of conditions. For example, an operation or determination described as “based on condition A” may be based on both a condition A and a condition B without departing from the scope of the present disclosure, and the phrase “based on” shall be construed in the same manner as the phrase “based at least in part on.”

Although implementations for device actions based on authenticated multi-touch gestures have been described in language specific to features and/or methods, the appended claims are not necessarily limited to the specific features or methods described. Rather, the specific features and methods are disclosed as example implementations for device actions based on authenticated multi-touch gestures, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a mobile device comprising a fingerprint sensor, and a multi-touch authentication module, implemented at least partially in hardware of the mobile device, to receive, via the fingerprint sensor, a multi-touch gesture that includes at least a first touch event and a second touch event, collect first authentication data during the first touch event and second authentication data during the second touch event, and cause a device action corresponding to the multi-touch gesture to be performed based on a successful authentication of at least one of the first authentication data or the second authentication data.

In some aspects, the techniques described herein relate to a mobile device, wherein the first touch event and the second touch event are received within a specified timeout period.

In some aspects, the techniques described herein relate to a mobile device, wherein the specified timeout period define a first duration of time during which the multi-touch gesture is to be completed, or a second duration of time during which consecutive individual touch events of the multi-touch gesture are to be received.

In some aspects, the techniques described herein relate to a mobile device, wherein the multi-touch authentication module is configured to receive, after the specified timeout period, a third touch event that is not included as part of the multi-touch gesture.

In some aspects, the techniques described herein relate to a mobile device, wherein the multi-touch gesture is a combination of touch events that includes at least one of: one or more tap events, one or more touch and hold events, one or more touch and swipe events, or one or more touch and rotate events.

In some aspects, the techniques described herein relate to a mobile device, wherein the multi-touch authentication module is configured to initiate different device actions in response to different multi-touch gestures being received, the different multi-touch gestures including different types of touch events.

In some aspects, the techniques described herein relate to a mobile device, wherein the multi-touch gesture corresponds to different device actions as performed by different fingers of a user.

In some aspects, the techniques described herein relate to a mobile device, wherein, to receive the multi-touch gesture, the multi-touch authentication module is configured to receive a threshold number of individual touch events, and prevent a subsequent touch event from being included as part of the multi-touch gesture.

In some aspects, the techniques described herein relate to a mobile device, wherein the multi-touch authentication module is configured to impose a lockout of the fingerprint sensor in response to a threshold number of unsuccessful authentication attempts, the multi-touch gesture that includes multiple touch events corresponding to a single authentication attempt.

In some aspects, the techniques described herein relate to a mobile device, wherein the multi-touch authentication module is configured to cause a different device action to be performed based on an unsuccessful authentication of authentication data collected for each individual touch event of the multi-touch gesture.

In some aspects, the techniques described herein relate to a mobile device, wherein the multi-touch authentication module is configured to initiate the mobile device being unlocked when the multi-touch gesture is received, cause the different device action as an application of the mobile device being launched, and cause the device action as the application of the mobile device being launched and a login to a user account associated with the application.

In some aspects, the techniques described herein relate to a mobile device, wherein the multi-touch authentication module is configured to initiate the mobile device being locked when the multi-touch gesture is received, and cause the device action as the mobile device being unlocked using at least one of the first authentication data or the second authentication data and an application of the mobile device being launched.

In some aspects, the techniques described herein relate to a method comprising receiving, via a fingerprint sensor of a mobile device, a multi-touch gesture that includes at least a first touch event and a second touch event, collecting first authentication data during the first touch event and second authentication data during the second touch event, identifying, based on the first authentication data and the second authentication data, a particular finger with which the multi-touch gesture is input, and causing a device action corresponding to the multi-touch gesture and the particular finger to be performed based on a successful authentication of at least one of the first authentication data or the second authentication data.

In some aspects, the techniques described herein relate to a method, wherein the multi-touch gesture corresponds to different device actions as performed by different fingers of a user.

In some aspects, the techniques described herein relate to a method, wherein the receiving the multi-touch gesture includes receiving a threshold number of touch events, and preventing a subsequent touch event from being included as part of the multi-touch gesture.

In some aspects, the techniques described herein relate to a method, further comprising imposing a lockout of the fingerprint sensor in response to receiving a threshold number of unsuccessful authentication attempts, the multi-touch gesture that includes multiple touch events corresponding to a single authentication attempt.

In some aspects, the techniques described herein relate to a method, wherein the mobile device is locked when the multi-touch gesture is received, and the device action is to unlock the mobile device using at least one of the first authentication data or the second authentication data and launch an application of the mobile device

In some aspects, the techniques described herein relate to a method comprising receiving, via a fingerprint sensor of a mobile device, sequential touch events including at least a first touch event and a second touch event, collecting, during the first touch event, first authentication data and first touch data indicating a first type of gesture for the first touch event, collecting, during the second touch event, second authentication data and second touch data indicating a second type of gesture for the second touch event, identifying, based on the first type of gesture and the second type of gesture, a particular multi-touch gesture of a plurality of multi-touch gestures, and causing a device action corresponding to the particular multi-touch gesture to be performed based on a successful authentication of at least one of the first authentication data or the second authentication data.

In some aspects, the techniques described herein relate to a method, wherein the plurality of multi-touch gestures include different combinations of at least one of: one or more tap events, one or more touch and hold events, one or more touch and swipe events, or one or more touch and rotate events.

In some aspects, the techniques described herein relate to a method, further comprising receiving additional sequential touch events including at least a third touch event and a fourth touch event, identifying, based on third touch data collected during the third touch event and fourth touch data collected during the fourth touch event, a different multi-touch gesture of the plurality of multi-touch gestures, and causing a different device action corresponding to the different multi-touch gesture to be performed based on a successful authentication of at least one of third authentication data associated with the third touch event or fourth authentication data associated with the fourth touch event.

1. A mobile device comprising:
a fingerprint sensor; and
a multi-touch authentication module, implemented at least partially in hardware of the mobile device, to:
receive, via the fingerprint sensor, a multi-touch gesture that includes at least a first touch event and a second touch event;
collect first authentication data during the first touch event and second authentication data during the second touch event; and
cause a device action corresponding to the multi-touch gesture to be performed based on a successful authentication of at least one of the first authentication data or the second authentication data.

2. The mobile device of claim 1, wherein the first touch event and the second touch event are received within a specified timeout period.

3. The mobile device of claim 2, wherein the specified timeout period defines:
a first duration of time during which the multi-touch gesture is to be completed; or
a second duration of time during which consecutive individual touch events of the multi-touch gesture are to be received.

4. The mobile device of claim 2, wherein the multi-touch authentication module is configured to receive, after the specified timeout period, a third touch event that is not included as part of the multi-touch gesture.

5. The mobile device of claim 1, wherein the multi-touch gesture is a combination of touch events that includes at least one of: one or more tap events, one or more touch and hold events, one or more touch and swipe events, or one or more touch and rotate events.

6. The mobile device of claim 1, wherein the multi-touch authentication module is configured to initiate different device actions in response to different multi-touch gestures being received, the different multi-touch gestures including different types of touch events.

7. The mobile device of claim 1, wherein the multi-touch gesture corresponds to different device actions as performed by different fingers of a user.

8. The mobile device of claim 1, wherein, to receive the multi-touch gesture, the multi-touch authentication module is configured to receive a threshold number of individual touch events, and prevent a subsequent touch event from being included as part of the multi-touch gesture.

9. The mobile device of claim 1, wherein the multi-touch authentication module is configured to impose a lockout of the fingerprint sensor in response to a threshold number of unsuccessful authentication attempts, the multi-touch gesture that includes multiple touch events corresponding to a single authentication attempt.

10. The mobile device of claim 1, wherein the multi-touch authentication module is configured to cause a different device action to be performed based on an unsuccessful authentication of authentication data collected for each individual touch event of the multi-touch gesture.

11. The mobile device of claim 10, wherein the multi-touch authentication module is configured to:
initiate the mobile device being unlocked when the multi-touch gesture is received;
cause the different device action as an application of the mobile device being launched; and
cause the device action as the application of the mobile device being launched and a login to a user account associated with the application.

12. The mobile device of claim 1, wherein the multi-touch authentication module is configured to:
initiate the mobile device being locked when the multi-touch gesture is received; and
cause the device action as the mobile device being unlocked using at least one of the first authentication data or the second authentication data and an application of the mobile device being launched.

13. A method comprising:
receiving, via a fingerprint sensor of a mobile device, a multi-touch gesture that includes at least a first touch event and a second touch event;
collecting first authentication data during the first touch event and second authentication data during the second touch event;
identifying, based on the first authentication data and the second authentication data, a particular finger with which the multi-touch gesture is input; and
causing a device action corresponding to the multi-touch gesture and the particular finger to be performed based on a successful authentication of at least one of the first authentication data or the second authentication data.

14. The method of claim 13, wherein the multi-touch gesture corresponds to different device actions as performed by different fingers of a user.

15. The method of claim 13, wherein the receiving the multi-touch gesture includes receiving a threshold number of touch events, and preventing a subsequent touch event from being included as part of the multi-touch gesture.

16. The method of claim 13, further comprising imposing a lockout of the fingerprint sensor in response to receiving a threshold number of unsuccessful authentication attempts, the multi-touch gesture that includes multiple touch events corresponding to a single authentication attempt.

17. The method of claim 13, wherein the mobile device is locked when the multi-touch gesture is received, and the device action is to unlock the mobile device using at least one of the first authentication data or the second authentication data and launch an application of the mobile device.

18. A method comprising:
receiving, via a fingerprint sensor of a mobile device, sequential touch events including at least a first touch event and a second touch event;
collecting, during the first touch event, first authentication data and first touch data indicating a first type of gesture for the first touch event;
collecting, during the second touch event, second authentication data and second touch data indicating a second type of gesture for the second touch event;
identifying, based on the first type of gesture and the second type of gesture, a particular multi-touch gesture of a plurality of multi-touch gestures; and
causing a device action corresponding to the particular multi-touch gesture to be performed based on a successful authentication of at least one of the first authentication data or the second authentication data.

19. The method of claim 18, wherein the plurality of multi-touch gestures include different combinations of at least one of: one or more tap events, one or more touch and hold events, one or more touch and swipe events, or one or more touch and rotate events.

20. The method of claim 18, further comprising:
receiving additional sequential touch events including at least a third touch event and a fourth touch event;
identifying, based on third touch data collected during the third touch event and fourth touch data collected during the fourth touch event, a different multi-touch gesture of the plurality of multi-touch gestures; and
causing a different device action corresponding to the different multi-touch gesture to be performed based on a successful authentication of at least one of third authentication data associated with the third touch event or fourth authentication data associated with the fourth touch event.
